(19) United States
(12) Patent Application Publication
(10) Pub. No.: US 2016/0195887 A1
(43) Pub. Date: Jul. 7, 2016

(54) Development of certain mechanical heat profiles and their use in an automated optimization method to reduce energy consumption in commercial buildings during the heating season

(71) Applicant: Patrick Andrew Shiel, Dublin (IE)

(72) Inventor: Patrick Andrew Shiel, Dublin (IE)

(21) Appl. No.: 14/966,300

(22) Filed: Dec. 11, 2015

Related U.S. Application Data
(63) Continuation-in-part of application No. 14/606,989, filed on Jan. 27, 2015, now Pat. No. 9,317,026.
Application No. 14/606,989 is a continuation-in-part of application No. 13/906,822, filed on May 31, 2013, now Pat. No. 8,977,405.
Application No. 13/906,822 is a continuation-in-part of application No. 13/374,128, filed on Dec. 13, 2011, now abandoned.

(51) Int. Cl. G05F 1/66; G06F 17/11; G05B 13/04

(52) U.S. Cl. CPC G05F 1/66; G05B 13/041; G06F 17/11

(57) ABSTRACT

The invention teaches a system and method for reducing energy consumption in commercial buildings. The invention provides development of certain mechanical heat profiles and use of such profiles in an automated optimization method. Outputs communicate with the building management system of the commercial building, and regulate the heating system during a season when the building activates the heating system. Various embodiments are taught.

### RELATED APPLICATIONS

This application is a continuation in part of U.S. application Ser. No. 14/606,989 by the same inventor, entitled Method for determining the unique natural thermal lag of a building, filed Jan. 27, 2015, docket SHIEL003, publication number US2015-0198961 A1. The entirety of application Ser. No. 14/607,003 is incorporated by reference as if fully set forth herein.

This application is also related to U.S. application Ser. No. 13/906,822, entitled Continuous Optimization Energy Reduction Process in Commercial Buildings, filed May 31, 2013, docket SHIEL002, now U.S. Pat. No. 8,977,405, the entirety of which is incorporated by reference as if fully set forth herein.

This application is also related to U.S. application Ser. No. 14/607,011, entitled Building Energy Usage Reduction by Automation of Optimized Plant Operation Times and Sub-Hourly Building Energy Forecasting to Determine Plant Faults, filed Jan. 27, 2015, docket SHIEL005, and where the entireties of SHIEL005 is incorporated by reference as if fully set forth herein.

### GOVERNMENT FUNDING

None

### FIELD OF USE

The invention is useful in energy management, and more particularly in the field of energy management in commercial buildings.

### BACKGROUND

Energy use analysis in commercial buildings has been performed for many years by a number of software simulation tools which seek to predict the comfort levels of buildings while estimating the energy use. The underlying principles of these tools concentrate on thermal properties of individual elements of the building itself, such as wall panels, windows, etc. The complexity and level of detail required to accurately simulate a commercial building often makes its use prohibitive. The accuracy of such models has also been called into question in the research material. Following the construction and occupation of a new commercial building, the installed plant, such as boilers and air conditioning equipment, whose function is to provide suitable occupant comfort, is usually controlled by a building management system (BMS).

Through practical experience within the construction industry, it has become known that this plant is often over-sized and the use of the plant is often excessive. Common examples of this include plant operating for significantly longer than required including unoccupied weekends, heating and cooling simultaneously operating in the same areas due to construction or control strategy problems and issues with overheating and the use of cooling to compensate. Where the common problem of overheating occurs, the building envelope is quite efficient in dumping excess heat by radiation. In a similar manner, where buildings are over-cooled in summer, buildings are very effective in absorbing heat from the external environment to compensate. The utilization of this plant is not normally matched to the building envelope in which it operates and it is the intention to show how the method can help with this matching process.

U.S. Pat. No. 8,977,405 and publication US2015-0198961 A1 represent a series of methods developed to provide a high-level view of thermal performance in a commercial building. This view is quick to implement and easily understood by facilities and maintenance staff. The methods facilitate a better understanding of the thermal performance of a building envelope, as constructed, and the interaction between this envelope and the building's heating and cooling plant, as installed. The thermal performance of the building envelope and how it interacts with the plant has been expressed as a series of time lags and profiles which are functions of external temperature and solar activity. External temperature remains the most influential of the external weather parameters on energy usage. The lags and profiles have been developed to be derived from data which is readily available within modern conventional buildings.

### BRIEF SUMMARY OF THE INVENTION

Following U.S. Pat. No. 8,977,405, where the derivation of a building's natural thermal lag and the solar gain lag were presented, and publication US2015-0198961 A1 where a less data intensive method to calculate the natural thermal lag was presented, the following is an explanation of how the natural thermal lag can be used to derive a series of thermal profiles which can be combined to achieve automated optimization of thermal energy usage in commercial buildings during the heating season. While the absolute values of these lags, as they vary with external temperature, are important building thermal parameters in their own right, the profile of the relationship between these lag values and external temperature, as it varies over the full year's weather seasons, is more revealing about the building's thermal characteristics. In certain climates, the inclusion of solar activity in the lag relationship is required. This is for the simple reason that, depending on the building envelope, high solar activity during winter can affect the amount of heating required in a building, particularly in warm climates.

Two unique building thermal parameters have been defined. Unlike the building's natural thermal lag and solar gain lag described previously these parameters are derived from data while the building is being mechanically heated. They include mechanical heat-up rate and night-time natural cooldown profile slope.

The mechanical heat-up rate is a measure of how quickly the average space temperature in a suitable number of open spaces in a building reaches the desired heating set-point as measured from the space temperature at the time the heating system was started. This is measured in ° F./min and the mechanical heat-up rate will vary depending on the internal temperature observed when the heating systems switched on.

The night-time natural cooldown profile slope is a measure of how quickly the average space temperature in a suitable number of open spaces in a building naturally falls after mechanical heating has been switched off. It is the rate at which this cooldown happens naturally and has been shown to depend on the average daily lagged external temperature. The slope is measured from the time the mechanical heating stops to the time the mechanical heating starts up again (usually the following morning).

Both thermal parameters are dependent on the average daily lagged external temperature where the amount of lag applied has been determined by the building's natural thermal lag.

Both thermal parameters, which are unique to this commercial building, are used in combination with the weather forecast, particularly the forecast of external temperatures, to estimate the likely internal space temperature which will be present at the time the heating system will commence operation. The amount of time required to bring the internal space temperature to the desired set-point can also be estimated and with this information, it is possible to determine an optimum starting time for the heating system as a function of average daily lagged external temperature.

This invention provides a system and method to reduce the thermal energy used in a commercial building by use of thermal parameters which are derived from readily-available data both internal and external to the building.

### BRIEF DESCRIPTION OF DRAWINGS

The drawings listed are provided as an aid to understanding the invention

FIG. 1 Plot of test building B1 natural thermal lag as a function of external temperature. External temperature is shown for reference

FIG. 2 B1 mechanical heat-up lag profile as observed on January 9^{th}/10^{th} year 3 (black) and the 4-hour lagged external temperature on the same days. The times for mechanical heat on and off are also indicated. Following heat on, the natural cool-down profile is shown for both days

FIG. 3a Inventive Process Steps 100-150

FIG. 3b Inventive Process Steps 160-200

FIG. 3c Inventive Process Steps 210-280

FIG. 3d Inventive Process Steps 290-330

FIG. 4a Physical connections from building management system to plant and Modbus over IP

FIG. 4b—Inventive system connecting to the BMS Modbus over IP network

FIG. 5 B1 agreed energy baseline data

FIG. 6 B1 short-term space temperature monitoring pre-interventions (March 25th to April 20th year 1) in 1^{st} floor open area

FIG. 7 B1 Air-CO₂ concentration levels recorded in an open office space on 25th March year 1 prior to any energy efficiency interventions

FIG. 8 B1 benchmark (BM) usage versus CIBSE usage ranges for heat and electricity

FIG. 9 B1 thermal profile statistical models derived from on-site and observed data

FIG. 10 First interventions made to the B1 BMS April year 1. For reference, LPHW is equivalent to heating and CHW is the equivalent of cooling

FIG. 11 High level list of B1 interventions—April year 2 to May year 3 (significant interventions are highlighted)

FIG. 12 Total heat delivered to B1—over a four year period with the commencement of the energy efficiency programme indicated

FIG. 13 Total chilling delivered to B1—over a four year period with the commencement of the energy efficiency programme indicated

FIG. 14 Annual energy use outcomes for P1 over the four year period

FIG. 15 Comparison of electricity and gas equivalent usage over calendar baseline year versus year 3

FIG. 16 Total B1 energy usage over a four year period

FIG. 17 B1 short-term space temperature monitoring post-interventions March 25th to April 20th, (bold) with the earlier profile shown (dotted)

FIG. 18 B1 short-term space Air-CO₂ concentration levels monitored on March 25^{th} year 3 (bold) with the earlier equivalent profile shown (dotted)

### DETAILED DESCRIPTION OF A PREFERRED EMBODIMENT OF THE INVENTION

The invention provides a method performed by a system which connects directly to a commercial building management system (abbreviated as BMS).

This section describes the introduction of new thermal profiles, the manner in which these profiles along with the natural thermal lag described in U.S. Pat. No. 8,977,405 and publication US2015-0198961 A1 can be applied to the control of plant in a particular building, and finally, the application of these concepts to an actual building and the energy reduction results.

Following U.S. Pat. No. 8,977,405, where the derivation of a building's natural thermal lag was presented, and publication US2015-0198961 A1 where a less data intensive method to calculate the natural thermal lag was presented, the following is an explanation of how the natural thermal lag, along with a number of important thermal profiles, can be combined to achieve automated optimization of energy usage in commercial buildings. The following sections recap how the natural thermal lag is derived in U.S. Pat. No. 8,977,405 and publication US2015-0198961 A1, and also show the derivations of the mechanical heat-up rate and the night-time natural cooldown profile slope. Both of these have been shown to be closely correlated to the average daily lagged external temperature where the amount of lag used in calculating the average daily lagged external temperature is determined by the building's unique natural thermal lag.

### Natural Thermal Lag

The derivation of the building-unique natural thermal lag can be summarized as follows (from U.S. Pat. No. 8,977,405 and publication US2015-0198961 A1).

The natural thermal lag (NTL) of a commercial building is a unique property which indicates how quickly the internal spaces of the building respond to changes in external temperature. The NTL can be derived as follows:
a) using previously recorded data within said commercial building being 12 months of internal and external temperature data recorded at 15-minute intervals while the building was at rest, or in other words, the building was not in use, had no plant operating and experienced less than 1 hour of solar activity during the day in question (U.S. Pat. No. 8,977,405). If internal temperature data is not available, the data used are energy consumption and external temperature data recorded at 15-minute intervals (publication US2015-0198961 A1)
b) deriving the natural thermal lag (NTL) of said commercial building by applying the sum of squares method (outlined in U.S. Pat. No. 8,977,405) on the 12 months of internal and external temperature data only on days when the building was at rest, where each value of NTL is calculated according to:

$${LagIndex}_{LW} = {\sum }_{i = 2 p}^{p} {( {T}_{{S}_{i}} - {T}_{{O}_{i - LW}} )}^{2}$$

wherein
LagIndex_{LW} is a sum of squares particular to a range of external temperatures indicated by a value LW,
p is a number of 15 minute observations examined,
Tₛ_{ᵢ} is an internal space temperature at time period i,
Tₒ_{_{i-LW}} is an outside temperature at LW periods prior to time period i.

If internal temperature is not available, apply the building energy to external temperature data regression analysis method as follows:

Eᵢ=β₀+β₁(LTᵢ)_{k=0.8}+εᵢ

where
Eᵢ represents average hourly energy usage for said building on day i,
β₀ represents a Y axis intercept of a linear relationship between energy and lagged temperature average,
β₁ represents a slope of a relationship between average hourly energy usage and a lagged temperature average (LTᵢ)_{k=0.8} for a day i and ranging over a period k from 0 to 8 hours prior to a building closing time,
ε is estimated variation.

The particular index of lagged average external temperature during the winter yields the low point of NTL sinusoid, while the particular index of lagged average external temperature during the summer yields the high point of the NTL sinusoid. This yields an approximated NTL plot over the full year (SHIEL003; publication US2015-0198961 A1).
c) Each NTL point (one for each day the building is at rest) can be plotted against the average external temperature recorded for that day. The relationship between the NTL and average daily external temperature can be established according to the regression equation:

NTLᵢ=β₀−β₁Toutᵢ+εᵢ

wherein
NTLᵢ is the natural thermal lag calculated on a particular day i
β₀ is the intercept of the linear relationship between NTL and the average daily external temperature Tout on the y-axis
β₁ is the slope of the linear relationship between NTL and the average daily external temperature Tout
Toutᵢ is the average daily external temperature calculated as the average of the 96 external temperature readings recorded during day i
εᵢ is the variability in the linear relationship.

Once the particular relationship between NTL and daily average external temperature is established for said commercial building, the NTL can be estimated for any given average daily external temperature.

### Natural Thermal Lag Profile

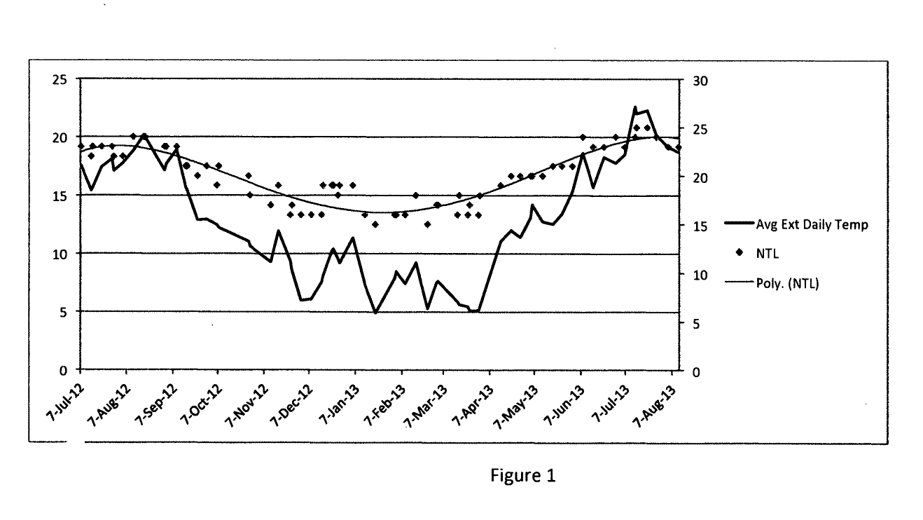

Plotting the individual values of the natural thermal lag derived from data for each day the building is at-rest is indicated in FIG. 1. From FIG. 1, it is evident that the NTL is strongly related to the average daily external temperature. The strength of that relationship for this building can be examined by linear regression in which daily average outside temperature Toutᵢ can be regressed against the observed NTL (based on results in SHIEL002).

This relationship can be statistically modelled as a simple linear regression of:

NTLᵢ=β₀−β₁Toutᵢ+εᵢ

The actual model derived for the test building B1 is:

NTL=12.93−0.555Tout±1.9

The parametric statistics which define this relationship are shown as an extract from the Minitab statistical analysis package:

### Regression Analysis: B1 NTL Versus Average Tout

The regression equation is

NTL=12.93+0.5546 Average Tout

### S=0.851145 R-Sq=91.7% R-Sq(adj)=91.6%

### Analysis of Variance

### Source DF SS MS F P

### Regression 1 539.462 539.462 744.65 0.000

### Error 67 48.538 0.724

### Total 68 588.000

This particular NTL response curve in FIG. 1 is defined by the high and low points. The curve remains consistently sinusoidal in following the pattern of average external temperatures from year to year. Therefore, it follows that if the high and low points are known, the annual NTL response curve can be estimated.

In SHIEL003, publication number US2015-0198961 A1, it has been shown how energy usage data of winter heating and summer cooling can be used to determine the optimum value of NTL for these seasons without any reference to internal temperature data.

In fact, these values of NTL for summer and winter represent the highest and lowest points of the sinusoid and therefore a method to determine the year-long NTL response for this building has been developed, based on energy usage and external temperature data alone.

This facilitates the simple estimation of the building's unique NTL to be used for energy efficiency purposes, in the event that rapid estimation is required or that a full year of internal space temperature data is unavailable.

The mechanical heat-up rate and the night-time cooldown profile slope are now defined. They are both useful in determining the best start times for heating plant based on the external temperature profile contained in a weather forecast. This section shows how these two thermal parameters can be applied to plant start times and are therefore used to reduce energy consumption in commercial buildings.

### Mechanical Heat-Up Rate

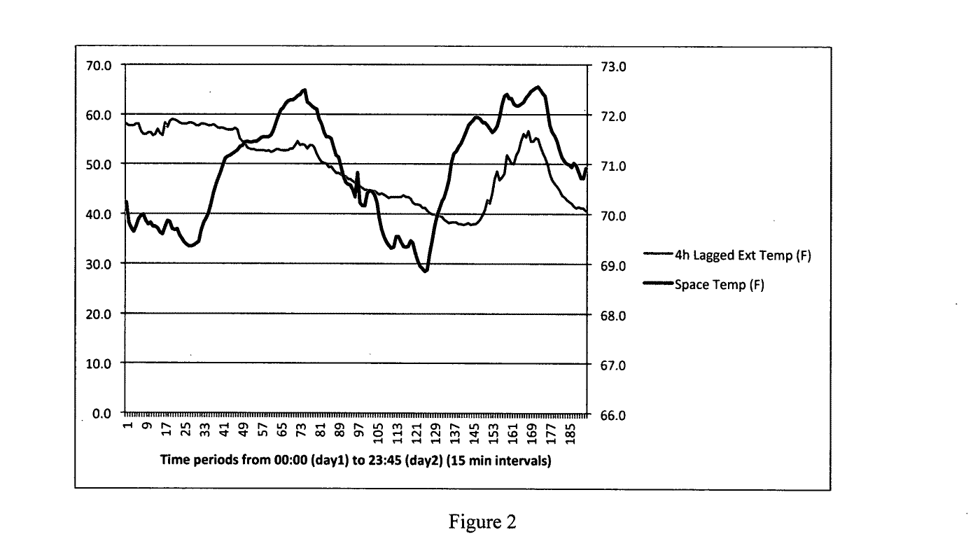

The mechanical heat-up rate (MHR) is a measure of how quickly the average space temperature in a suitable number of open spaces in a building reaches the desired heating set-point as measured from the space temperature at the time the heating system was started. See FIG. 2.

The MHR will vary depending on the internal temperature observed when the heating systems switched on. The MHR is defined as the rate of increase of space temperature from that observed at heating system on time to the time at which the set-point is reached and can be described as:

MHR_{p=1 . . . N}={(Tₛₑₜₚₒᵢₙₜ−T_{SP}_{ₜ₌₀})/tₛₑₜₚₒᵢₙₜ}ₚ

where Tₛₑₜₚₒᵢₙₜ is the internal space temperature setpoint (usually 72° F.)
T_{SP}_{ₜ₌₀} is the internal space temperature observed when the heating was started
tₛₑₜₚₒᵢₙₜ is the time required to heat the space from the starting temperature T_{SP}_{ₜ₌₀} to the required setpoint Tₛₑₜₚₒᵢₙₜ

Each value of MHR is calculated for each day the heating system operates. Recording the average daily lagged external temperature for each of these days yields a series of MHR_{p=1 . . . N} values for heating days 1 . . . N which can be plotted to show how the MHR varies with average daily lagged external temperature. It has been shown in practical use of this method that a linear regression relationship can be formed to show how the mechanical heat-up rate varies with average daily lagged external temperature. The amount of lag applied to determine the average daily lagged external temperature for this building is guided by the building's already determined natural thermal lag.

This relationship can be defined in general form as follows:

MHRᵢ=β₀−β₁ALaggedToutᵢ+εᵢ

wherein
MHRᵢ is the calculated mechanical heat-up rate on any given day i, on which the heating system is operating
β₀ represents the intercept of the linear relationship between mechanical heating rate and lagged external temperature, as guided by the NTL, on the y-axis
β₁ represents the slope of the relationship between MHRᵢ and lagged average external temperature ALaggedToutᵢ
ALaggedToutᵢ represents the value of average lagged external temperature, guided by NTL, and calculated for any given day i
ε represents variability.

### Night-Time Natural Cooldown Profile Slope (NNCPS)

The night-time natural cooldown profile slope (NNCPS) is a measure of how quickly the average space temperature in a suitable number of open spaces in a building naturally falls after mechanical heating has been switched off. It is the rate at which this cooldown happens naturally and has been shown to depend on the average daily lagged external temperature. The slope is measured from the time the mechanical heating stops to the time the mechanical heating starts up again (usually the following morning).

The NNCPS is derived by first finding the relationship between the space temperature and the difference between this space temperature and the lagged external temperature over the period while the mechanical heating is switched off.

A regression model is derived to show how the internal space temperature changes as a function of the difference between that space temperature and the lagged external temperature for each heating day by using an equation:

T_{SPi}=β₀−β₁(T_{SPi}−LaggedToutᵢ)+εᵢ

wherein
T_{SPi} is the internal space temperature recorded at time period i
β₀ represents the intercept of the linear relationship between the internal space temperature and the difference between the internal space temperature and the external lagged temperature, as guided by the NTL, on the y-axis
β₁ represents the slope of the relationship between the internal space temperature T_{SPi} and the difference between that temperature and the external lagged temperature LaggedToutᵢ at time period i
LaggedToutᵢ is the value of lagged external temperature, as guided by the natural thermal lag, observed for any given time period i
ε represents variability

The slope of this linear relationship β₁ is the NNCPS for this particular overnight period. By deriving several values of NNCPS, one for each day, and recording the average daily lagged external temperature during the same periods, a predictive relationship can be formed which indicates how the NNCPS will vary as a function of daily average lagged external temperature. This yields a series of NNCPS_{p=1 . . . N} values for heating days 1 . . . N. This is shown in generalized form as follows:

NNCPSᵢ=β₀−β₁ALaggedToutᵢ+εᵢ

wherein
NNCPSᵢ is the derived night-time natural cool-down profile slope on any given day i, on which the heating system is operating
β₀ represents the intercept of the linear relationship between NNCPS and daily average lagged external temperature as guided by the natural thermal lag on the y-axis
β₁ represents the slope of the relationship between NNCPSᵢ and daily lagged average external temperature ALaggedToutᵢ
ALaggedToutᵢ represents the value of daily average lagged external temperature guided by the natural thermal lag calculated for any given day i
ε represents the variability in the linear model

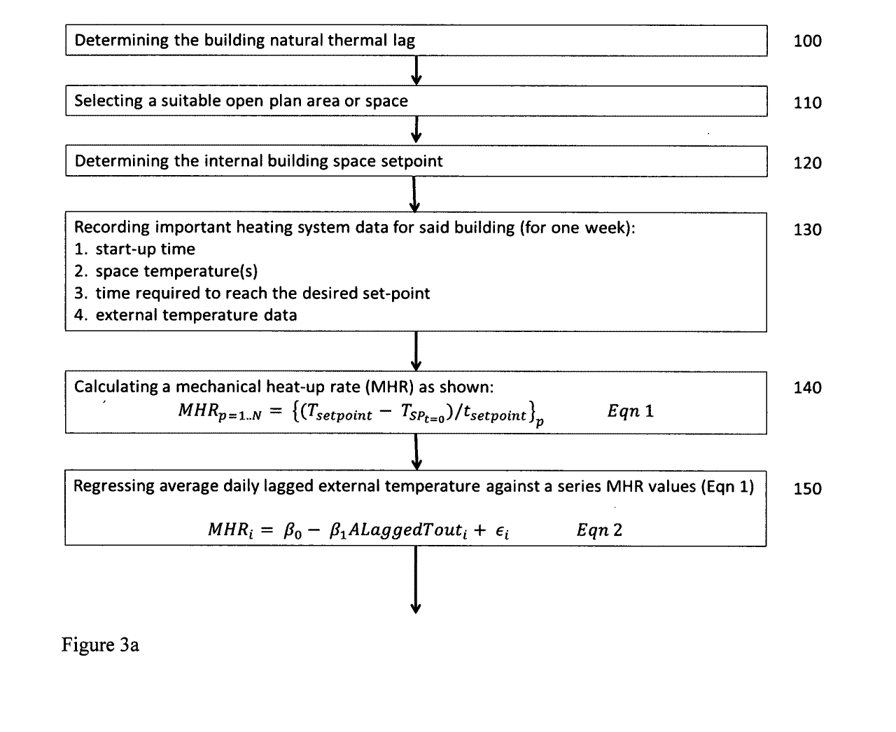

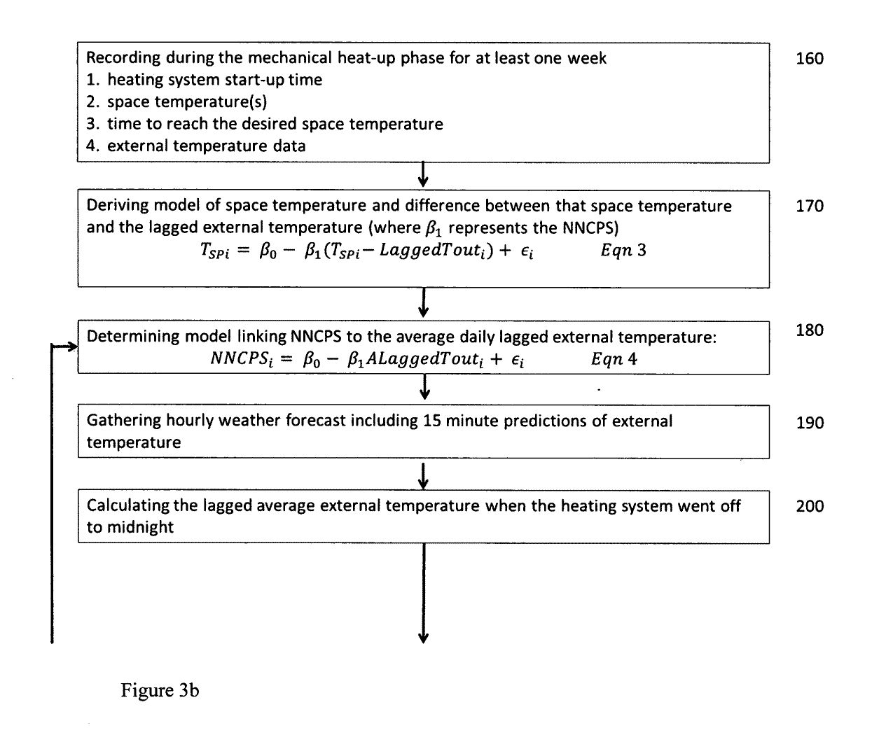

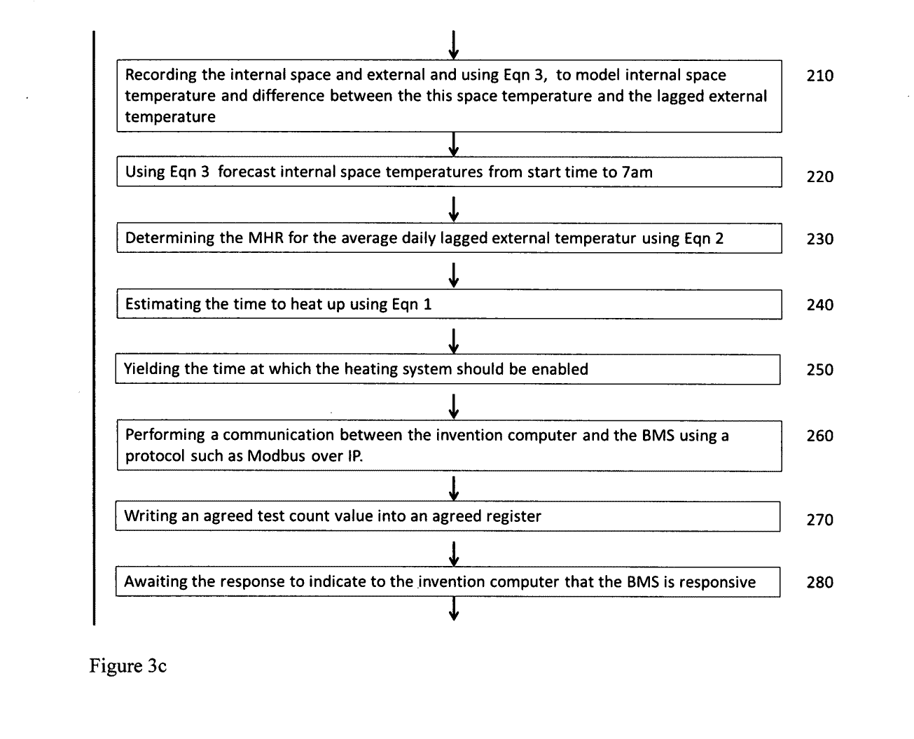

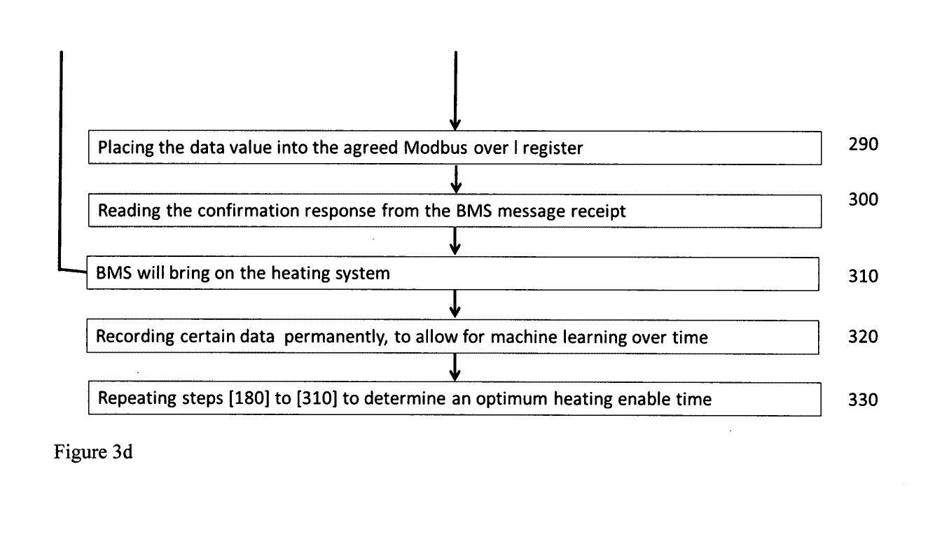

The inventive method is described in FIG. 3 and is explained in the following section.
a) Determining [100] the building natural thermal lag by the means shown—these have shown in the preceding sections. Two methods exist and which one is used is determined by the data available. The methods to derive the natural thermal lag are more fully explained in SHIEL002—US U.S. Pat. No. 8,977,405- and SHIEL003, publication number US2015-0198961 A1.
b) selecting [110] a suitable open plan area or space within said commercial building or a series of suitable open spaces in which to observe the space temperature(s).
c) determining [120] the internal building space setpoint for the current heating season. This is usually set at approximately 72° F. This is simply read off the building management system computer screen.
d) recording [130] the following data from the building management system computer screens and physically verified during the mechanical heat-up phase (usually in the morning) for said building:
   1. heating system start-up time
   2. space temperature(s) for the chosen open plan location(s), at this start-up time
   3. time required to reach the desired space temperature set-point (typically 72° F.)
   4. external temperature data in 15 minute intervals
   5. Record this data for a period of one week, or longer if building operations allow.
e) Calculating [140], using the recorded data, a mechanical heat-up rate (MHR) for each working day (i.e. a day building is occupied) using an equation:

MHR_{p= . . . N}={(Tₛₑₜₚₒᵢₙₜ−T_{SP}_{ₜ₌₀})/tₛₑₜₚₒᵢₙₜ}ₚ Eqn 1
where Tₛₑₜₚₒᵢₙₜ is the internal space temperature setpoint (usually 72° F.) T_{SP}_{ₜ₌₀} is the internal space temperature observed when the heating was started tₛₑₜₚₒᵢₙₜ is the time required to heat the space from the starting temperature T_{SP}_{ₜ₌₀} to the required setpoint Tₛₑₜₚₒᵢₙₜ
f) Recording [150] each average daily lagged external temperature for the day the MHR was calculated, where said lag is guided by the building's natural thermal lag. This yields a series of MHR_{p= . . . N} values for heating days 1 . . . N. A regression relationship can be established which links the MHR to the average daily lagged external temperature and this is shown in generalized form in Eqn 2:

MHRᵢ=β₀−β₁ALaggedToutᵢ+εᵢ Eqn 2
wherein
MHRᵢ is the calculated mechanical heat-up rate on any given day i, on which the heating system is operating
β₀ represents the intercept of the linear relationship between mechanical heating rate and lagged external temperature, as guided by the NTL, on the y-axis
β₁ represents the slope of the relationship between MHRᵢ and lagged average external temperature ALaggedToutᵢ
ALaggedToutᵢ represents the value of average lagged external temperature, guided by NTL, and calculated for any given day i
ε represents the variability in the linear model.

Once the particular lagged external temperature is known, it is possible to forecast the approximate value of the MHR which will pertain to a commercial building based on a short-term weather forecast.
g) recording [160] the following data from the building management system computer screens and physically verified during the night-time natural cool-down phase in the evening for said building by recording:
   1. heating plant shut-down time
   2. space temperature(s) for the chosen open plan location(s) at this shut-down time (usually 72° F.)
   3. Space temperature(s) for the chosen open plan location(s) at the time when heating starts the following morning
   4. external temperature data in 15 minute intervals
   5. Record this data for a period of one week, or longer if building operations allow.
h) Deriving [170], using this recorded data, a regression model to show how the internal space temperature changes as a function of the difference between that space temperature and the lagged external temperature for each heating day using an equation:

T_{SPi}=β₀−β₁(T_{SPi}−LaggedToutᵢ)+εᵢ Eqn 3
wherein
T_{SPi} is the internal space temperature recorded at time period i
β₀ represents the intercept of the linear relationship between the internal space temperature and the difference between the internal space temperature and the external lagged temperature, as guided by the NTL, on the y-axis
β₁ represents the slope of the relationship between the internal space temperature T_{SPi} and the difference between that temperature and the external lagged temperature LaggedToutᵢ at time period i
LaggedToutᵢ is the value of lagged external temperature, as guided by the NTL, observed for any given time period i
ε represents the variability in the linear model.
i) determining [180] the night natural cool-down profile slope (NNCPS) on days the heating system is operating, to help estimate the starting point for the internal space temperature at heating start time for each day on which the heating is operating, repeat the process outlined in g), recording each average daily lagged external temperature and the slope of the regression relationship pertaining to that particular day, β₁ or NNCPS. In this regression model (Eqn 3), the slope β₁ will be referred to as the NNCPS.

This yields a series of NNCPS_{p=1 . . . N} values for heating days 1 . . . N. A relationship can be established which links the NNCPS to the average daily average lagged external temperature and this is shown in generalized form in Eqn 4:

NNCPSᵢ=β₀−β₁ALaggedToutᵢ+εᵢ Eqn 4

wherein
NNCPSᵢ is the derived night-time natural cool-down profile slope on any given day i, on which the heating system is operating
β₀ represents the intercept of the linear relationship between NNCPS and daily average lagged external temperature as guided by the natural thermal lag on the y-axis
β₁ represents the slope of the relationship between NNCPSᵢ and daily lagged average external temperature ALaggedToutᵢ
ALaggedToutᵢ represents the value of daily average lagged external temperature guided by the natural thermal lag calculated for any given day i
ε represents the variability in the linear model.
j) Gathering [190] the hourly weather forecast to include 15 minute predictions of external temperature for the following 8-12 hours, ensuring the forecast extends beyond the estimated winter natural thermal lag of the commercial building in question.
k) Calculating [200] at midnight or so, the lagged average external temperature over a data window starting when the heating system went off, using recorded 15-minute temperature data from that time to midnight or so.
l) Recording [210] the internal space and external temperatures from heating off time to midnight or so, and using the general model shown in Eqn 3, generate a model describing the relationship, during this heating off time (usually at night), between the recorded internal space temperature and difference between the this space temperature and the lagged external temperature.
m) Using [220] this model (Eqn 3), and the predicted lagged external temperatures in the weather forecast, forecast the likely internal space temperatures at each 15-minute period until occupancy start time, say, 7 a.m.
n) Determining [230] the MHR for the average daily lagged external temperature using recorded external temperatures in conjunction with those from the weather forecast using Eqn 2.
o) Estimating [240] the time to heat up, by knowing the likely MHR for this particular day, the heating set point and the internal temperature predicted in step l), and using Eqn 1.
p) Subtracting [250] this estimate of heat up time from the agreed occupancy start time, yields the time at which the heating system should be enabled.
q) Performing [260] a communication between the invention computer and the BMS using a protocol such as Modbus over IP. This communication will usually happen at the heating system on time. For example if the hex value of 0x1010 represents ‘Heating system ENABLE’ if placed in Modbus register 8006, as agreed with the BMS programmer.
r) Writing [270] an agreed test count value into an agreed register to ensure the BMS knows the invention computer is present and functional.
s) Awaiting [280] the response from the BMS, to indicate to the invention computer that the BMS is responsive.
t) Placing [290] the 0x1010 data value into the agreed Modbus over IP protocol register at the appropriate heating on time.
u) Reading [300] the confirmation response from the BMS in another register to confirm to the invention computer that the instruction to enable the heating system has been received.
v) Responding [310] to this writing of digital data (0x1010) into this register (8006), the BMS will bring on the heating system.
w) Recording [320] permanently, the observed 15-minute interval data for weather forecast, internal space temperatures and all other relevant data used in the above equations to facilitate more accuracy in the data regression models, to effectively allow for machine learning over time.
x) Repeating [330] steps i) to v) at an appropriate time (usually at the start of each day) to determine an optimum heating enable time during the heating season.

The method has been developed for practical implementation in real buildings. The majority of modern commercial buildings, be they office, retail, medical, educational, etc. are equipped with a building management system (BMS). The BMS is a computerized system which monitors vital parameters inside and outside the building and depending on the particular building-specific control strategy, the BMS will respond by switching plant on/off or if the plant has variable control, increasing/decreasing the level of output. Because of the need for high levels of reliability, availability and serviceability, most BMS are highly distributed in nature, meaning that one section of the BMS is completely independent of the others. This removes the risk of single points of failure in the overall system. The BMS hardware architecture therefore consists of control points (referred to as out-stations) which are autonomous but network connected. Each of these out-stations might monitor such things as several space temperatures and control multiple heating and cooling devices, in response to these monitored readings. The overall collection or framework of out-stations, monitors and controls go to make up the BMS. There are many manufacturers of these systems throughout the World; the largest might include companies such as Siemens (GR), Honeywell (US), Johnson Controls (US) or Trend (UK).

The most common form of communications within the BMS framework is a low level protocol called ModBus. This protocol was developed within the process control industry (chemical plants, oil refineries, etc.) and it dates from the earliest forms of computer control. The implementation concept of ModBus is that of addressable registers which are either readable, writable, or both. The easiest way to imagine the implementation is that of pigeon-holes. So with this protocol, it is possible to use a computer device, equipped with a ModBus hardware interface, to request the reading of a register (say register 8002) which might represent some space temperature (value can vary between 0000 and FFFF (in Hexadecimal) which, let's say, represents a temperature range of 0° F. to +200° F.). On reading this space temperature, the algorithm in the connected computer can now determine the response, so if the reading is 0x5EB8 (representing 74° F.), the computer might request that the heating valve be lowered and this is done by writing a new value to another register, say register 8006. The BMS will interpret this value and act accordingly. This assumes, of course, that the BMS is set up or programmed to monitor these registers and act accordingly. This protocol must be agreed with the BMS programmer in advance so that both sides of the ModBus registers are aware of the meaning and mapping of register addresses and values.

### Physical Connections

In the practical implementation of this system, the physical connection to the BMS is normally achieved over an industry-standard Internet Protocol (IP) network. This is the same type of network installed in a standard office or commercial building. Much development has been done by the BMS manufacturers in recent years to get the BMS protocols, such as ModBus, to function over a standard Ethernet or IP network. This has led to ModBus over IP. If a new computer is introduced to this Modbus over IP network, the new computer is simply assigned an IP address by the network administrator and thereafter, that computer can issue read and write commands over IP, once the map of registers is known to the new computer. As mentioned, this map is known to the BMS programmer, so the introduction of the new computer would preferably happen with the knowledge and agreement of the BMS programmer. The BMS programmer may assign certain rights and privileges to the new computer thus dictating what it can read and what it can control by register writes.

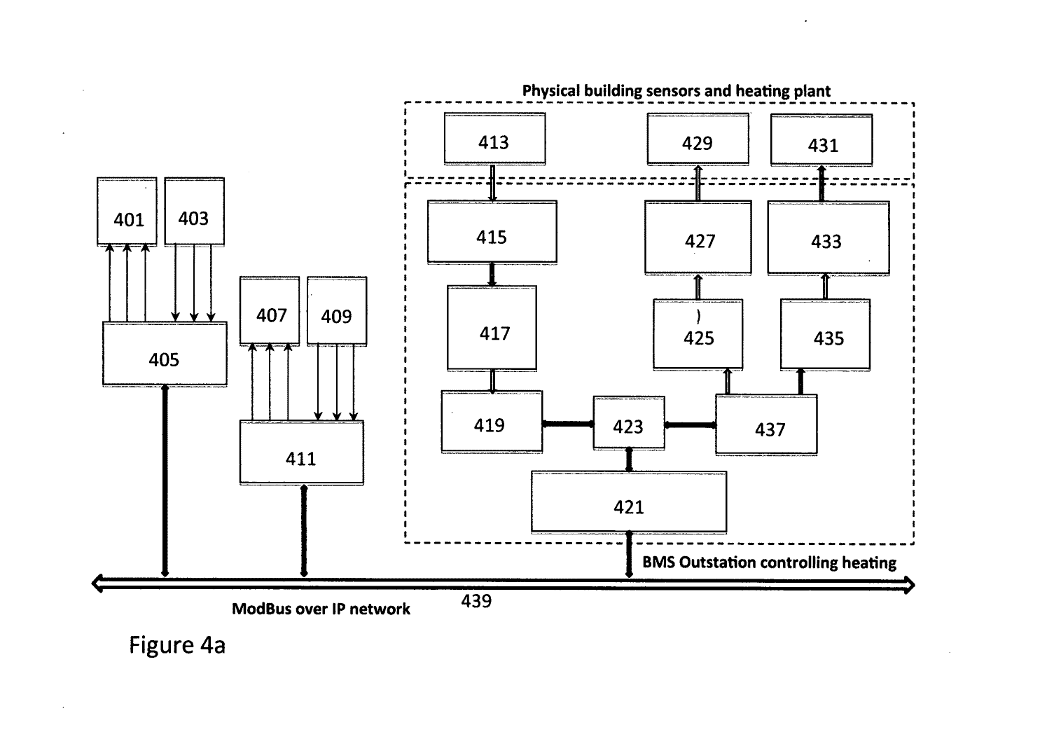

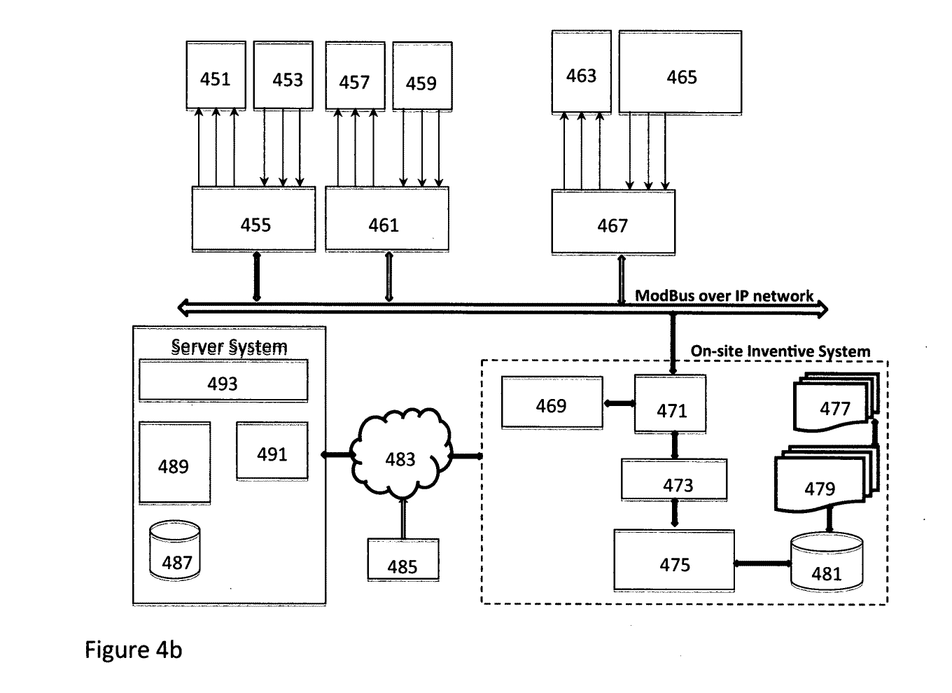

A typical configuration is shown in FIG. 4a indicating a simple logical layout of the BMS outstations which are assigned to control and/or monitor various sections of plant in a typical commercial building, such as heating, cooling and fresh air supply from air handling units. The outstation which is assigned to controlling the heating system is expanded in FIG. 4a to indicate how this outstation can monitor space temperatures and react accordingly by enabling or disabling the boiler or increasing or decreasing the heating pump speed to affect more or less heating being introduced into a space. The connections from the outstation to the physical pieces of plant or sensors are typically 3 or 4 core-shielded cable. A typical connection between the BMS in FIG. 4a and the Inventive System and method is shown in FIG. 4b.

FIG. 4a depicts an illustration of an implementation of a Modbus connected building management system showing the following physical, logical and functional blocks:

401—Control outputs to chiller is typically a simple 0-5 v control signal to enable the operation. The signals also are used to enable the operation of cooling system primary and secondary pumps. If variable frequency drives are installed, this control group will also use a 0-10 v (or 4-20 mA) voltage (or current) controller to vary the speed of these pumps, depending on demand.
403—Status inputs from chiller is typically a Modbus connection which allows the chiller and variable frequency drives (if installed) inform the BMS of various operating parameters such as internal temperatures, speed of rotation, number of compressors in use at any time, etc. These inputs will also include status inputs from the pumps sent from a current transformer that will tell the BMS if the pumps are operating.
405—BMS outstation controlling cooling is a BMS out-station that contains the necessary control and monitoring devices to control the building's cooling system.
407—Control outputs to AHU are typically a simple run enable 0-5 v digital signal that turns the air-handling unit on or off and various 0-10 v analog valve controls to modulate the temperature of the supply airflow.
409—Status inputs from AHU will allow the air-handling unit to signal various important temperature and air flow parameters to the BMS.
411—BMS outstation controlling fresh air supply is a BMS out-station that contains the necessary control and monitoring devices to control the building's fresh air supply via air handling units.
413—Physical temperature sensor is the physical device typically wall or ceiling mounted which measures local temperature.
415—0-10 v input connected to 1^{st} floor ceiling temperature sensor is the physical device within the BMS out-station to which the temperature sensor is wired. Readings of temperature can vary between zero and ten volts, the value of which represents a manufacturer's range of temperatures. The reference to 1^{st} floor is purely by way of illustration. There will be several of these sensors in a commercial building.
417—1^{st} floor space temperature register 8002 (read/only) is an illustration of an assigned register address within the Modbus register map which relates to this temperature sensor.
419—Modbus register read control is the module within the BMS, which ensures correct timing of read requests to the physical device to which it is connected.
421—Outstation control strategy logic and Modbus interface manager is the intelligence programmed into the BMS to tell it how to control the pieces of plant such as the heating or cooling systems. It also controls data access to and from the Modbus network.
423—Modbus register map contains the agreed assigned register addresses of each piece of physical hardware to which the BMS needs access over the Modbus network.
425—Heating boiler enable register 8008 (write/only) is an illustration of a write only register to which the correct data value can be written and which will result in the boiler being enabled with a digital ON/OFF signal.
427—Digital signal 0-5 v where 5 v represents boiler enable is the physical output from the BMS, which can be switched from zero to five volts to represent the switching on or enabling of the boiler.
429—Physical heating plant, which is expecting a digital signal to signify if it should turn on or off. The boiler will have further internal controls to ensure no overheating, etc.
431—Physical heating pump speed controller is an illustration of a physical variable frequency drive controlling a pump's speed or the pump itself being switched on or off by contactor. The BMS controls are capable of controlling either situation.
433—0-10 v output to the variable frequency heating pump control is the analog signal varying between zero and ten volts to signify the speed at which the heating pump should run.
435—Heating pump speed control register 8010 (write/only) is an illustration of an assigned Modbus address for the speed control of the heating pump.
437—Modbus register write control is the module within the BMS which ensures correct timing of write requests to the physical device to which it is connected.
439—Modbus over IP network is the Modbus transport and protocol layers which run over a standard Ethernet network.
FIG. 4b depicts an illustration of an implementation of a Modbus connected building management system with the Inventive System attached showing the following physical, logical and functional blocks:
451—Control outputs to chiller is typically a simple 0-5 v control signal to enable the operation. The signals also are used to enable the operation of cooling system primary and secondary pumps. If variable frequency drives are installed, this control group will also use a 0-10 v (or 4-20 mA) voltage (or current) controller to vary the speed of these pumps, depending on demand.
453—Status inputs from chiller is typically a Modbus connection which allows the chiller and variable frequency drives (if installed) inform the BMS of various operating parameters such as internal temperatures, speed of rotation, number of compressors in use at any time, etc. These inputs will also include status inputs from the pumps sent from a current transformer which will tell the BMS if the pumps are operating.
455—BMS outstation controlling cooling is a BMS out-station which contains the necessary control and monitoring devices to control the building's cooling system.
457—Control outputs to AHU are typically a simple run enable 0-5 v digital signal that turns the air-handling unit on or off and various 0-10 v analog valve controls to modulate the temperature of the supply airflow.
459—Status inputs from AHU will allow the air-handling unit to signal various important temperature and air flow parameters to the BMS.
461—BMS outstation controlling fresh air supply is a BMS out-station that contains the necessary control and monitoring devices to control the building's fresh air supply via air handling units.
463—Control outputs to heating system is a group of groups to enable the boilers and control heating pumps. These control signals are typically carried on physical 3 or 4-core shielded cables.
465—Status inputs from physical heating system and space temperature sensors is a group of inputs from components of the heating system such as pump running indicators, various heating water flow/return temperatures, building space temperatures, etc. These input signals are typically carried on physical 3 or 4-core shielded cables.
467 BMS Out-station controlling heating is the physical BMS outstation that carries out the control and monitoring of the building's heating system.

### Inventive System Modules

469 BMS live status monitor is a module that ensures that the connection to the BMS and Modbus network is physically and logically present.
471 Modbus interface manager ensures the correct flow of messages to and from the Modbus network.
473—BMS interface manager holds the agreed list of BMS specific commands, message structures and Modbus addresses to ensure correct mapping of Modbus registers to functional blocks within the BMS.
475—NTL, MHR and NNCPS calculation algorithms is a software module which takes monitored data and constantly updates the calculated building thermal parameters as described in this document for the more efficient control of the building heating plant.
477—Schedule files is a storage location for all plant schedules as determined by the continuous calculation of the thermal parameters based on recorded building data and the short-term weather forecast.
479 Temperature setpoints is a storage area for calculated setpoints as determined by the continuous calculation of the thermal parameters based on recorded building data and the short-term weather forecast.
481—Database is a local copy of the recorded building data such as space temperatures, etc.
483—Internet is the publically accessible IP network.
485—Weather forecast is a system which regularly retrieves a temperature and solar activity forecast for a location as close as possible to the building in question. This can also retrieve data from a building roof-mounted weather logging system.
487—Database is a large remote data storage area that holds a copy of all data held in the Inventive System locally within the building.
489—Status and reporting web service is a central facility for producing daily, weekly, monthly or annual reports of energy usage and building efficiency and producing alerts for unusual energy activity. These reports and alerts can be transmitted to the building owner/operator over the Internet.
491—Heating system optimizer in conjunction with 493 (Cloud-based replica of on-site system algorithms) contains the NTL. MHR and NNCPS algorithms unique to this building to facilitate the remote control of the energy management of this building if the local Inventive System suffers an outage due to technical difficulties.

### Control Strategy and Protocol

The control strategy is agreed with the BMS programmer and the register mapping is shared between the BMS and the new computer device. This allows the new computer device to read and write certain registers. As an illustration, let's say, the computer device reads all internal space temperatures and the BMS external temperature. With this data, the computer device can calculate the natural thermal lag for the building over a one day period. With these space temperature data and knowledge of the start and stop times for the heating system, the computer device can calculate the mechanical heat up rate (MHR) and night-time natural cooldown profile slope (NNCPS) which according to the MHR and NNCPS algorithms explained in this document, can result in the computer device writing to the heating plant ON register to enable the boilers. In this way, the computer device can influence the heating control strategy by bringing forward or pushing back the mechanical heating start-up time.

Several interlocks can be implemented between the computer device and the BMS. These ensure that the BMS knows the computer device is functional. If, for any reason, the computer device fails to respond to the regular ‘are you alive’ request from the BMS, the BMS will revert to the stored control strategy and its default operational schedules. In this way, in the event of computer device or communications failure, no down time should be experienced by the BMS or the building.

Test Building Implementation of this Method

The method involving the various lags and profiles was implemented in a building in Western Europe for a 36 month period-referred to herein as year 1, 2 and 3, after a baseline year. This building has been referred to as the test building or B1. B1 is a single-tenant premium office building located at a city-center business park. Arranged as six floors over basement carpark, it comprises almost 11,000 m² of usable office space (approximately 120,000 sq ft) and is concrete constructed with columns and cast in-situ flooring slabs. The building would be considered a heavy building unlike a more conventional steel-framed building and with that weight comes a larger thermal mass—slow to heat up and slow to cool down. All lag calculations were performed manually in preparation for their implementation in an automated computerized system.

Commencing with the establishment of an energy usage benchmark or baseline, the various lags and profiles were observed during the first month without any energy efficiency interventions. During this time, several open-office spaces were monitored and the internal and external temperatures were recorded. This data provided guidance for the initial assessment of how the lags might be successfully applied to the operation of the building plant. Note that the lags and lag profiles have been developed as (1) high level indicators of building envelope thermal performance and (2) indicators of how the building envelope interacts with the installed plant. In the B1 building, they have been used to guide reduced plant operations specifically to generate better energy efficiency in the use of plant to provide agreed levels of occupant comfort.

The following sections outline the baseline establishment, the specific actions taken as a result of the lag calculations and finally, the results of this implementation are described.

### P1 Energy Baseline

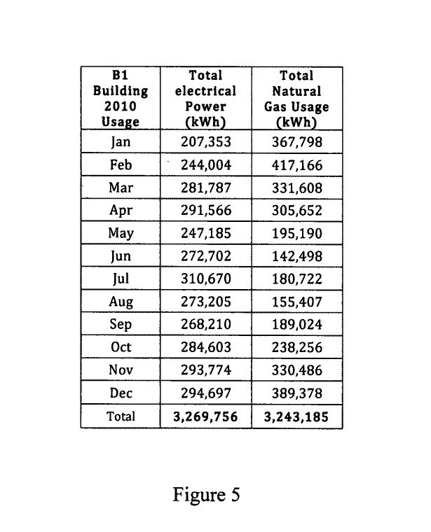

Before the energy reduction programme commenced, an energy usage baseline was agreed with the B1 building operator. After the operator had carefully considered the previous and following year's energy usage data and the weather experienced during these years, the figures from the full calendar year were selected as the most indicative of reasonable annual energy use. FIG. 5 shows the various agreed baseline energy loads in B1 over the course of the baseline year.

Please note that all units used in the implementation of the method for the B1 building and reported here are S.I. or metric units as that what is now customarily used in Europe by building and design personnel. Where possible, the equivalent units from the US Customary system have also been included.

### Short-Term Occupant Comfort Temperature Compliance March of Year 1 (Prior to any Energy Reduction Interventions)

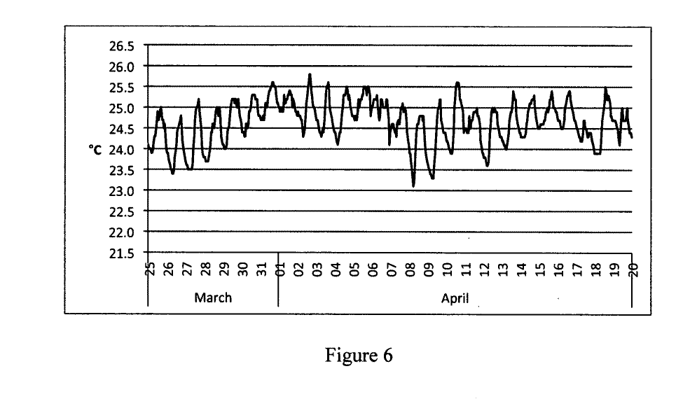

In order to show compliance with the national guidelines on occupant comfort temperature (from the UK and Ireland CIBSE Guide A), an environmental monitor was installed on March 24^{th}, year 1. The monitor was located in an internal open plan office area on the first floor at the northern side of the building. There are two such open areas on each floor. Almost four week's data were logged on a 15 minute basis before any energy reduction intervention was implemented. The space temperature profile is shown in FIG. 6. The CIBSE Guide A design guideline recommends a winter space temperature range of between 21° C. (70° F.) and 23° C. (73.5° F.) for office buildings, during office hours. Winter ranges can be applied to this period, given full heating was still in operation in B1.

On examination of the data, and with the Guide A guidelines in mind, certain observations can be made—
Space temperature never dropped below 23.0° C. (73.4° F.)—day or night. The building was being heated at night, probably needlessly
Space temperature often exceeded 25° C. (77° F.) during the working day and at weekends, which was beyond the Guide A recommendations
The temperature range fluctuated between 23.1° C. (73.6° F.) and 25.9° C. (78.6° F.) and when compared to the aforementioned design guidelines, exceedence or out-of-range temperatures greater than the recommended winter maximum of 23° C. (73.4° F.) were evident 100% of the time

The space temperature measured on the 1^{st} floor of B1 during this charted period is seldom within the recommended limits for the heating period of between 21° C. (70° F.) and 23° C. (73.4° F.). The space is considerably warmer and, as such, it could be assumed that the space is overheated, during the heating season of September to May.

In conjunction with space temperature, the Air-CO₂ concentration was also monitored and this is shown in FIG. 6.

The building is occupied from approximately 0730 to 1730 and this is reflected in the lowered parts per million (ppm) of CO₂ outside of these hours. The following could be observed from the chart data:
Outside of office hours, the air quality is equivalent to outdoor fresh air
Air-CO₂ concentrations continue to improve after the occupants have left the building indicating the AHU is still operating
Air-CO₂ concentrations start to rise gradually as occupants arrive, getting to 540 ppm at the peak (at 1130), which is very low
Occupants can be observed to leave the monitored space between times of 1230 and 1330 and CO₂ concentrations decrease
The Air-CO₂ concentrations in this space never rise above 550 ppm on a day of full occupation.

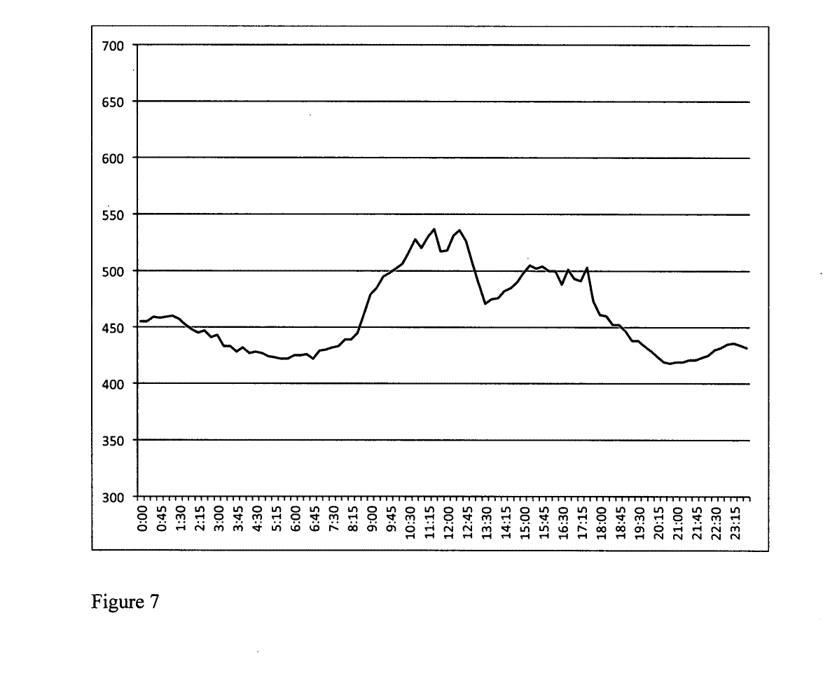

The combination of observations shown for FIGS. 6 and 7 give rise to the conclusion that this space is being over-ventilated and over-heated by tempered fresh air. This places an unnecessary load on the (1) and air handling units, (2) the heating system and probably (3) the cooling system attempting to cool down over-heated areas to maintain set-points.

### Identifying Energy Reduction Opportunities

Prior to April of year 1, the B1 building was operated on a full 24/7 basis with all plant enabled to run most of the time. This can be verified by the BMS plant schedules witnessed in February of year 1. The space temperature profiled in FIG. 6 seems to indicate that the heating is running for 24 hours of each day, with space temperature never falling below 23° C. (73.4° F.) Over the course of the previous number of years, it had become commonplace to have the building in use late at night and in some cases, overnight. As a result, it was the practice of the maintenance staff to simply leave the plant running rather than risk an office space or meeting room being too cold or too warm overnight. The BMS schedules, together with the control strategies and the daily space temperatures available on the BMS, were analysed in detail to determine the best opportunities for energy reduction. The following section outlines the conclusions reached from this analysis.

In order to determine the building's actual operational hours, it was suggested to security staff that an informal log might be kept of approximate staff numbers using the building late at night and over the weekends. These observations, over a two month period, showed that the building was lightly used overnight and at weekends, varying between 10 and 25 people at any time at weekends.

### P1 Overheating

Prior to April of year 1, the amount of thermal energy being driven into the building from the P1 boilers far exceeded the tabulated average values from the CIBSE design and operation guidelines. According to CIBSE Guide A, thermal energy input to an office building should be in the vicinity of 210 kWh/m²/yr for typical usage and 114 kWh/m²/yr for good practice usage. B1 was consuming 347 kWh/m²/yr during the course of the baseline year, based on a usable office space figure of 9,350 m² (approximately 100,000 sqft).

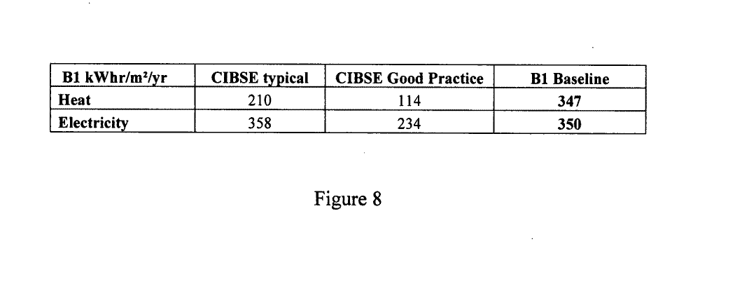

Likewise, electricity usage numbers were 350 kWh/m²/yr in the baseline year, while the CIBSE usage guideline for typical office buildings was 358 kWhr/m²/yr and 234 kWh/m²/yr for good practice office buildings. The energy usage figures from CIBSE for typical office, good practice office and actual baseline year are shown in FIG. 8.

### B1 Over-Chilling

Once the overheating issue was identified, the amount of chilling going into B1 also came under scrutiny. It was suspected that the over-heating of the building had a direct effect on the amount of chilling demanded by the individual fan coil units (FCU) on all floors. The BMS schedules for heating and chilling were first examined in February of year 1 and found to be running close to 24 hours per day.

It was reasonable to assume that the chiller schedule, starting at 2 am, was set up to avoid overheating during the early morning hours. If overheating could be reduced, the amount of chilling required might also be reduced.

### B1 Oversupply of Fresh Air

The air handling units (AHU) were scheduled to run on a 24/7 basis. Given the B1 boilers were similarly scheduled, this meant the building was being supplied with tempered air at all times. Again an energy reduction opportunity presented itself based on the recommended fresh air flow in CIBSE Guide A at between 6 and 15 l/s/person (litres/sec/person), depending on the design parameters. This is almost identical to recommendations in ASHRAE Standard 55 for buildings in the USA. The four AHUs in B1, operating at full power, can deliver 28,000 l/s into the building. Significant losses in airflow are inevitable in the long non-linear ducts between AHU and office vents, but from the ventilation design, the fresh air supply is well in excess than that required for the current 500 occupants. The designers would have sized the AHUs for a maximum number of occupants, particularly in meeting rooms and open areas, such as the restaurant. With a reduced staff count at weekends, a reduced airflow is also possible. With the AHUs installed in B1, there was no mechanism to reduce the fan speeds—they are either on or off.

Monitoring of CO₂ levels in open plan offices areas (shown in FIG. 8) showed that while the building is fully occupied, the level of fresh air is very high as indicated by the CO₂ readings (650 after 30 min of no fresh air). The recorded air quality suggested that while the AHUs could be turned off periodically during occupied hours for maybe up to one hour, a better solution would be to simply reduce the very high airflow emanating from the AHUs. With this in mind, variable frequency drives were recommended and installed.

Changing B1 BMS from Demand Driven to Schedule Driven Operation

When first analysed, the BMS was found to have been programmed as a demand-driven system. The underlying assumption is that heating and cooling were available from the main plant at all times and one relies on the correct functionality of the local FCUs to use the heat and cooling resources as required.

One of the potential drawbacks of demand driven systems can manifest itself if FCUs are left permanently on or are malfunctioning. There is a possibility that a heating and/or cooling load could always exist, whether the space is in use or not. In any case, the fact that the boiler or chiller is enabled overnight will create a load just to keep these systems available in standby.

It was recognised during April of year 2, that substantially better control could be achieved if the BMS was changed from demand driven to time schedule driven. This would allow observation and confirmation of occupant comfort temperature compliance given various small and incremental changes to the delivered environment. In changing to a time schedule control strategy, a much finer level of control would be available and it would be possible to lower the amount of the heat delivered to P1 in a controlled manner. It was hoped the amount of chilling required by P1 could also decrease with the smaller amount of delivered heat. The calculation of the various lags and profiles were facilitated by this change from a demand to a schedule driven BMS strategy. The changes to plant operations suggested by these lags and profiles could also be more easily implemented with a schedule driven system.

### Summary of B1 MHR and NNCPS Statistical Models

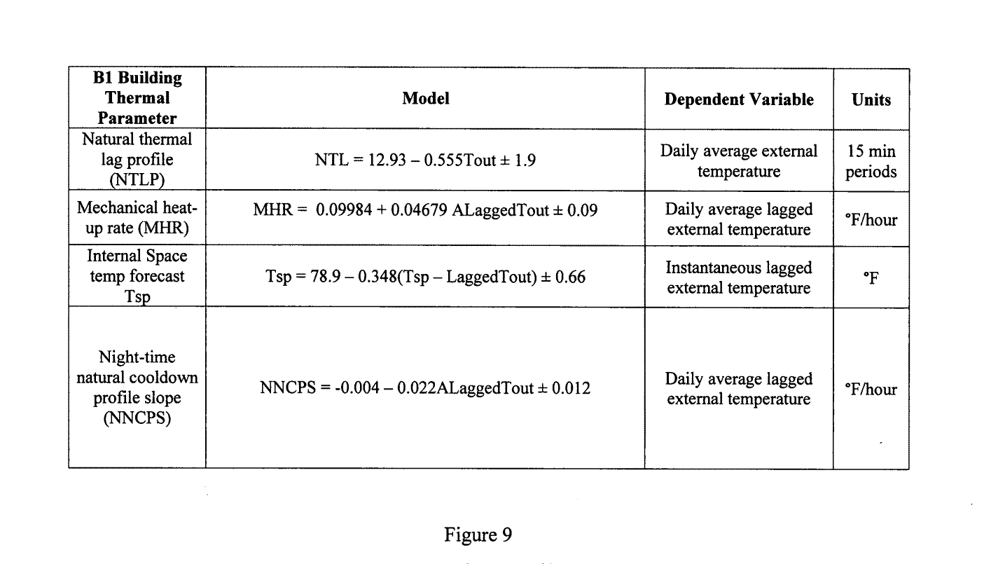

Following data collection from existing sources such as the BMS, newly installed monitoring equipment and observation, the following models were derived from this data. Data mainly comprised local external temperature and global radiation (sunshine), internal space temperatures and CO₂ levels (various) and energy usage by plant type (boiler). These data proved sufficient to complete the profile model calculations as indicated in FIG. 9.

### Implementation of Energy Reduction Programme

The practical application of the invention taught herein to the B1 building forms part of an overall energy efficiency program. Many measures were implemented simultaneously or following each other over a comparatively short timescale, This was done as it would prove commercially impossible to separate out all of the individual measures and accurately report on the reduction effects of each one. For this reason, the figures showing the energy usage reduction in the following sections are for the complete program, rather than just the implementation of the material contained in this specification. However, the use of the mechanical heat-up rate and the night-time natural cooldown profile slope both contributed to the dramatic changes in energy efficiency in the heating of the B1 building.

The following sections are intended to show the gradual changes made to the BMS plant schedules. This occurred over an 18 month period. The pace of the BMS schedule updates ensured no sudden or noticeable environmental changes in B1.

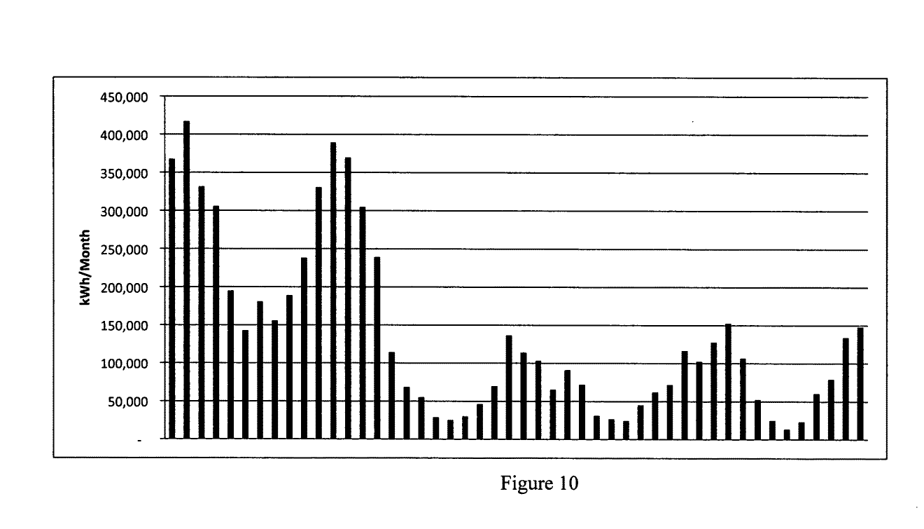

The energy reduction programme has primarily focussed on the large plant and equipment. The first interventions concern the heating, chiller and ventilation schedules. FIG. 10 shows the first changes made on 1^{st} April of year 1.

It is evident from the schedules in FIG. 10 that the heating and chilling were reduced soon after interventions commenced in an effort to examine the effects of less heat. Note that the airflow into the building is still being mechanically tempered 7-days per week.

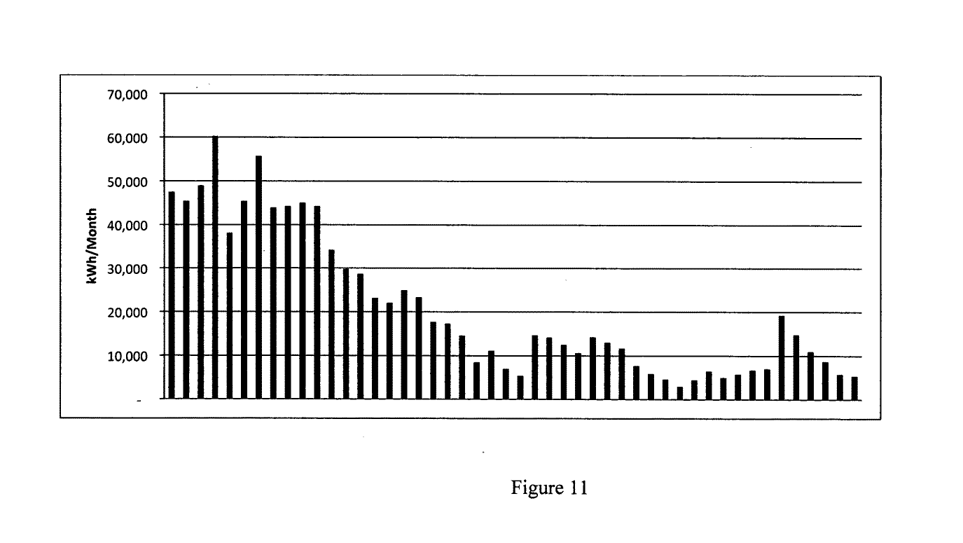

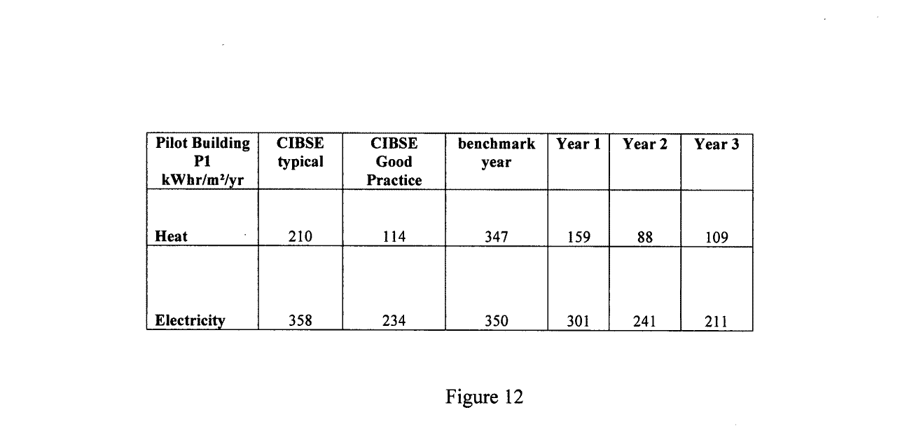

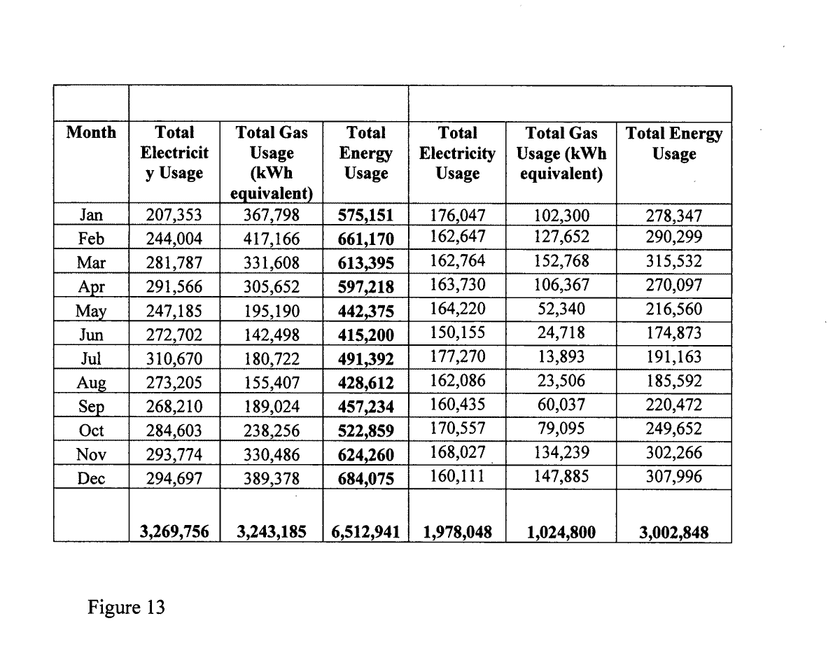

FIG. 11 shows a high level list of B1 interventions from April of year 1 to May of year 2. Significant interventions, which resulted in large energy reductions, are shown highlighted. The energy use charts over this period for electricity and gas (FIG. 12 and FIG. 13) are shown in the next section. The six major interventions are highlighted on the overall energy use chronological chart (FIG. 11) to show their effect on energy usage.

A number of the listed interventions are operational in their nature while others, such as those on 9/6/year 1 and 7/10/year 1, are attempts at solving building equipment issues which were affecting energy reduction efforts.

Note the change that occurred on February 25 of year 2 when the BMS was upgraded to a more recent version. This enabled the full control of the recently installed Variable Frequency Drives (VFDs) on the AHU fan motors. It also allowed for logging of certain important data points in B1 on a 15-minute basis. A VFD is an electrical device that is capable of running a large electric motor at a variable speed. They are in common usage in the HVAC industry and are capable of running both fan and water pump motors. Given the occupancy patterns in B1, particularly at weekends, it was recommended that the four AHUs be equipped with these devices in an effort to further reduce energy consumption.

### Results of the Energy Reduction Programme

A number of important changes in BMS schedules and set-points resulted in reductions in energy use in B1 which will be enumerated in this section. The analysis of heating and chilling patterns guided by the mechanical heat and cooling lags and the equivalent natural cooling lags, were also instrumental in identifying the inefficiencies which caused B1 to be over-supplied with both heat and chilling.

The energy usage in B1 had been divided into fixed and variable energy sinks. To re-cap, heating in summer is confined to Domestic Hot Water or DHW and cooling during the winter months is limited to serving locations of B1 which over-react to winter heating. For this reason, the use of the air-chiller has been shown to be relatively constant over the winter months just as the heating load or DHW is relatively constant in summer. This effectively divides energy use in B1 into landlord and tenant usage. Landlord usage is a common concept in commercial buildings where the landlord is responsible for supplying heating, cooling and ventilation and these services are often separately metered. The tenant part is that which is used on each floor such as small loads due to local power and lighting. It is the part of the overall energy bill normally paid for directly by the tenant.

The chart in FIG. 11 shows the heating delivered to B1 from January of the baseline year 1 to December of year 3. The commencement of the energy efficiency programme is indicated as March/April of year 1. The heat delivered to B1 in summer is for hot water only.

The lowering trend in heat energy consumed in B1 is apparent from this graph. Once control was gained over the level of heat being introduced to the building, the usage was observed to fall. Several of the early interventions during April and May of year 1 contributed to this decrease.

The cooling delivered to B1 over the same period of January of the baseline year to December of year 3 is shown in FIG. 13, again with the indicator showing the commencement of the energy efficiency programme.

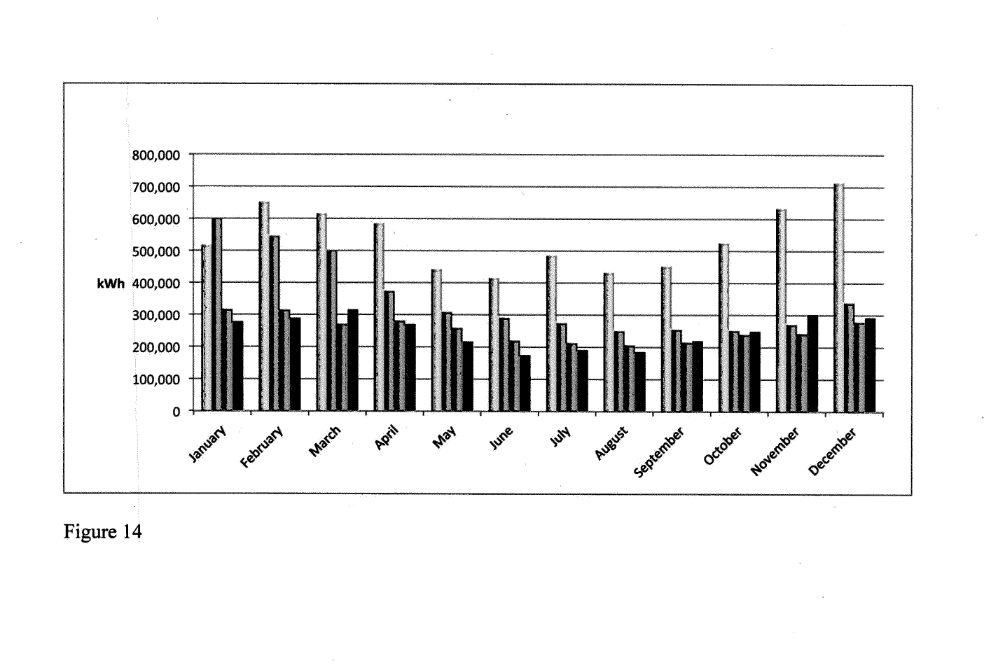

From the graph in FIG. 13, it can observed that during the periods of May and June of year 1, and February and March of year 2, higher chiller usage due to the external temperature being higher than normal for that time of year, by comparison with the neighbouring and traditionally warmer months. The energy usage for the baseline through third years are shown in FIG. 14. This table shows gas and electricity usage as compared to the CIBSE typical and CIBSE Good Practice averages. It is evident from this data that the usage has steadily decreased over the indicated period and that the energy consumption in B1 has come more in line with CIBSE Good Practice. The increase in heat or gas usage for year 3 when compared with the previous year, 109 versus 88, occurred in the final four months of year 3. During this period, November was colder than normal, but during the period, certain technical difficulties had arisen with the boiler sections and these were being worked on.

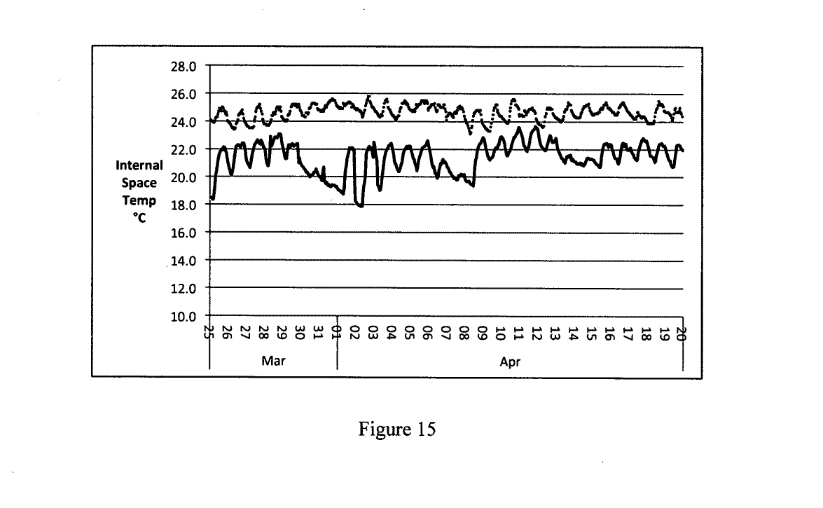

FIG. 15 contains a simple comparison of electricity and gas or heat equivalent numbers.

This compares the energy consumption on a monthly basis over the course of the baseline year with the equivalent month in year 3.

FIG. 15 shows the drop in total annual energy used during the one year period for the benchmark year compared to the one year periods from January year 1 to December year 3. For year 3, the reduction equates to 54% from the benchmark figures in total energy consumption.

The energy usage pattern continues to show year-on-year improvement equating to reductions of 34% in year 1, 53% in year 2 and 54% in year 3. This is consistent with the energy reduction process as described in SHIEL002, U.S. Pat. No. 8,977,405. The continuous iterations to find out-of-control or poorly controlled plant continues and the improvements are evident but naturally slowing down considerably.

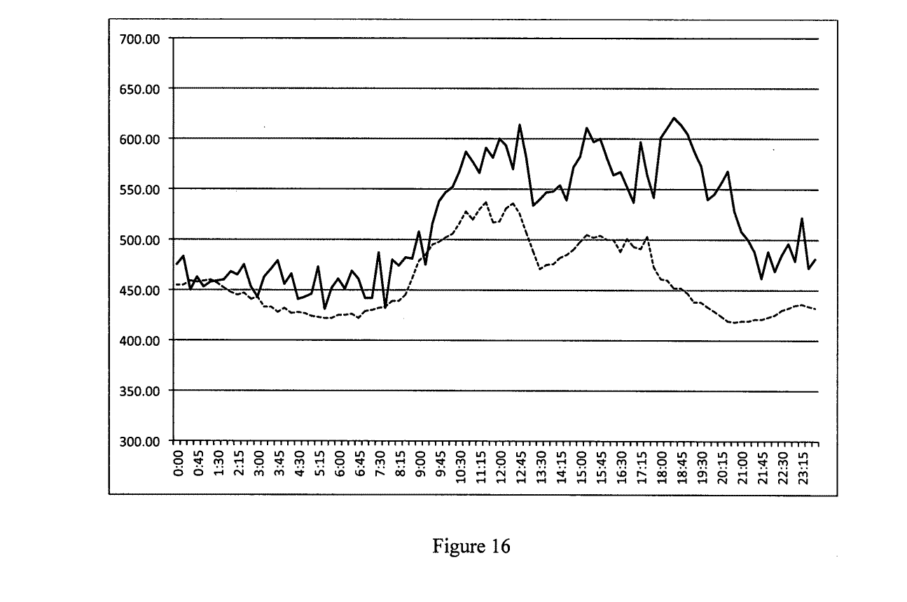

The air quality and temperature experienced in the same open plan area of B1, measured during March of year 1, prior to any energy efficiency interventions was constantly monitored during the three year process. The temperature profile from March of year 3 is shown in FIG. 17. Also shown are the Air-CO₂ concentration levels with the reduced AHU running speeds and times in FIG. 18. From FIG. 17, it is evident that the general temperature level has fallen in this open plan office space. The overnight temperatures are now responding to external temperature falls and the weekend, with little or no occupancy is evident. The desired set-point temperature of 22° C. is being reached on all working days. The lower temperature has the added benefit of more moisture in the air, since it is not as warm as before (March of year 1). The informal response from occupant in this area has been one of approval and one particular occupant who suffers with a dry-throat issue, has reported a noticeable improvement in her environment.

The Air-CO₂ concentration levels have become slightly higher based on the observed data plotted in FIG. 18. This is still well within acceptable limits for these concentrations. Any readings up to approximately 1100-1200 ppm are still considered to represent an acceptable environment.

Closing remarks. The savings achieved in B1 represent an overall saving of 54% based on a direct comparison of year 3 versus the baseline year total energy consumption figures. It is clear that B1, as with many other buildings that have been examined, that substantial overheating was the norm. This in turn, caused substantial over-cooling to compensate. Both heating and cooling are expensive services in any western country and they should be limited to what is required for the building to provide a good working environment to occupant. When considering the quality of the thermal environment of any commercial building, there is nothing to be gained from overheating or overcooling.

Building plant has been sized to cater for the worst weather conditions and the maximum number of occupants. Whether these maximum conditions are ever met, is unclear, but equipment such as chillers, air handling units and boilers are very large consumers of power and gas and as such, they need to be controllable, rather than simply turned on and off.

The system and method described in this document, along with the lags described in SHIEL002—U.S. Pat. No. 8,977,405—and SHIEL003—publication number US2015-0198961 A1—were applied to this building. This application resulted in substantial improvement and reduction of energy usage, while preserving the delivery occupant comfort, and in certain respects, such as air quality, improving it.

1. A method to reduce thermal energy consumption of a commercial building while maintaining occupant comfort, said method providing a heating system start-up time adjusted at least once each day for short range weather forecast, said method comprising:
a) determining said building's natural thermal lag;
b) selecting an internal space of said building for obtaining internal temperatures;
c) determining said internal building space temperature setpoint
d) recording for a predetermined number of days during said building's mechanical heat-up
i. heating system start-up time
ii. temperature of said internal space at heating system start-up time
iii. time period until said temperature set-point reached
iv. external temperature data in 15 minute intervals;
e) calculating, using data of step d), a mechanical heat-up rate (MHR)
MHR_{p=1 . . . N}={(Tₛₑₜₚₒᵢₙₜ−T_{SP}_{ₜ₌₀})/tₛₑₜₚₒᵢₙₜ}ₚ
where Tₛₑₜₚₒᵢₙₜ is an internal space temperature setpoint
T_{SP}_{ₜ₌₀} is an internal space temperature at heating system start-up
tₛₑₜₚₒᵢₙₜ is time period to heat said internal space from a starting temperature T_{SP}_{ₜ₌₀} to a temperature setpoint Tₛₑₜₚₒᵢₙₜ;
f) recording average daily lagged external temperature for a day an MHR was calculated, yielding a series of MHR_{p=1 . . . N} values for heating days 1 . . . N, establishing a regression relationship linking an MHR to an average daily lagged external temperature
MHRᵢ=β₀−β₁ALaggedToutᵢ+εᵢ
wherein
MHRᵢ is a calculated mechanical heat-up rate on day i,
β₀ represents a y-axis intercept of a linear relationship between mechanical heating rate and lagged external temperature
β₁ represents a slope of a relationship between MHRᵢ and lagged average external temperature ALaggedToutᵢ
ALaggedToutᵢ represents a value of average lagged external temperature, calculated for day i
ε represents variability;
g) recording over a preselected period for said building:
i. time heating plant shuts-down
ii. said internal space temperature at time heating plant shuts-down
iii. said internal space temperature at heating plant start-up time
iv. external temperature data in 15 minute intervals;
h) deriving, using data from step g), change in said internal space temperature as a function of a difference between said internal space temperature and a lagged external temperature
T_{SPi}=β₀−β₁(T_{SPi}−LaggedToutᵢ)+εᵢ
wherein
T_{SPi} is an internal space temperature recorded at time period i
β₀ represents a y-axis intercept of a linear relationship between internal space temperature and a difference between an internal space temperature and an external lagged temperature,
β₁ represents a slope of a relationship between an internal space temperature T_{SPi} and a difference between internal space temperature and an external lagged temperature LaggedToutᵢ at time period i
LaggedToutᵢ is a value of lagged external temperature for time period i
ε represents variability;
i) determining, using the steps of h), a night natural cool-down profile slope (NNCPS) yielding a series of NNCPS_{p=1 . . . N} values 1 . . . N. thereby establishing a relationship linking an NNCPS to an average daily average lagged external temperature expressable as
NNCPSᵢ=β₀−β₁ALaggedToutᵢ+εᵢ
wherein
NNCPSᵢ is a derived night-time natural cool-down profile slope on day i
β₀ represents a y-axis intercept of the linear relationship between NNCPS and daily average lagged external temperature
β₁ represents a slope of a relationship between NNCPS and daily lagged average external temperature ALaggedToutᵢ
ALaggedToutᵢ represents a value of daily average lagged external temperature on day i
ε represents variability;
j) gathering an hourly weather forecast for a period of approximately 8-12 hours where said forecast includes 15 minute predictions of external temperature;
k) calculating at approximately midnight, a lagged average external temperature over a data window starting when said building's heating system shut off, using recorded 15-minute temperature data from a period of time commencing at time of heating system shut off to approximately midnight;
l) recording internal space temperatures and external temperatures from time of heating system shut off to approximately midnight, and using the equation set forth in step h), generating a model describing the relationship between recorded internal space temperature and differences between space temperature and a lagged external temperature;
m) using the equation set forth in step h) and a predicted lagged external temperatures in a weather forecast to forecast internal space temperatures at 15-minute periods until occupancy start time
n) determining a Mechanical Heat-up Rate for an average daily lagged external temperature using recorded external temperatures in conjunction with weather forecast using the equation of step f)
o) estimating a building heat-up time using a Mechanical Heat-up Rate for day i, a heating set point and an internal temperature predicted in step l), and using the equation of step e);
p) subtracting said estimate of building heat up time of step o) from occupancy start time to determine an activation time of said building's heating system;
q) performing a communication to said building's Building Management System
r) writing a preselected test count value into a preselected register
s) receiving a response from said Building Management System
t) placing a data value into said preselected register thereby causing said building management system to activate said building's heating system at the time determined by step p)
u) reading a confirmation response from said Building Management System in a second preselected register to confirm to aninstruction to activate said building's heating system has been received
v) responding to step s), said building's Building Management System activates said building's heating system.

2. The method of claim 1 further including:
w) recording and storing an observed 15-minute interval data for weather forecast, internal space temperatures and all other relevant data used in the preceding steps to facilitate accuracy;
x) repeating steps i) to v) at a preselected interval to determine an optimum heating system activation time for a selected time of year.
